(19) United States
(12) Patent Application Publication
(10) Pub. No.: US 2010/0327802 A1
(43) Pub. Date: Dec. 30, 2010

(54) CHARGING DEVICE AND CHARGING SYSTEM HAVING SAME

(75) Inventor: KIM-YEUNG SIP, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO.,LTD., Shenzhen City (CN); HON HAI PRECISION INDUSTRY CO., LTD., Tu-Cheng (TW)

(21) Appl. No.: 12/543,513

(22) Filed: Aug. 19, 2009

(30) Foreign Application Priority Data
Jun. 29, 2009 (CN) 200910303810.3

(51) Int. Cl. H02J 7/00

(52) U.S. Cl. 320/108; 307/104

(57) ABSTRACT

A charging device includes a charging platform, a number of first electromagnetic induction devices, a first microprocessor, and a first current processing module. The first electromagnetic induction devices are disposed on the charging platform. The first microprocessor is configured for activating the first electromagnetic induction devices and identifying the first electromagnetic induction devices that generated effective differential signals. The first current processing module is configured for inputting an alternating current to the first electromagnetic induction devices selected by the first microprocessor.

### BACKGROUND

1. Technical Field

The present disclosure relates to charging devices and, particularly, to a charging device capable of charging a number of electronic devices simultaneously and a charging system having the charging device.

2. Description of Related Art

A portable electronic device, such as a cellular phone or a notebook, is typically powered by rechargeable battery that, when depleted of energy, can be charged by a charging device. However, a charging device usually can charge only one portable electronic device at a time. Therefore, if more than one portable electronic devices need to be charged at the same time, we should provide a number of charging devices to charge the portable electronic devices. This may be uneconomical and inconvenient.

What is needed, therefore, is a charging device and charging system having the same which can overcome the above-described problems.

### BRIEF DESCRIPTION OF THE FIGURES

FIG. 1 is a schematic view of an exemplary embodiment of the charging system according to the present disclosure.

FIG. 2 is a circuit diagram of a matrix of first electromagnetic induction devices of the charging system of FIG. 1.

FIG. 3 is a function block diagram of the charging system of FIG. 1, in accordance with an embodiment.

### DETAILED DESCRIPTION

Embodiments of the present disclosure will now be described in detail below, with reference to the accompanying drawings.

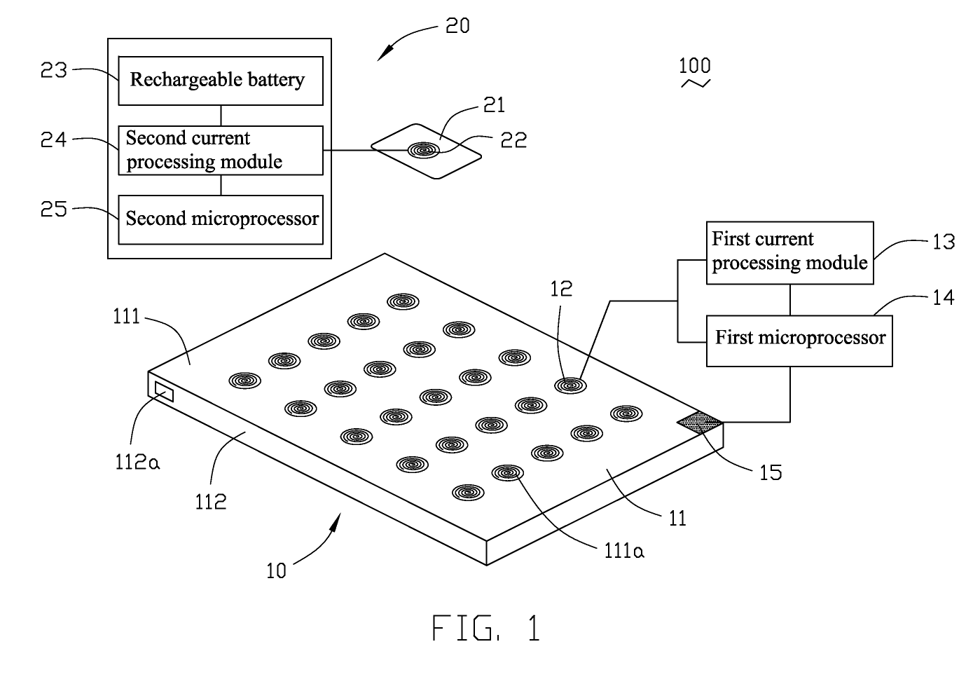

Referring to FIG. 1, a charging system 100, according to an exemplary embodiment, includes a charging device 10 and an electronic device 20. The charging device 10 is used for charging the electronic device 20.

The charging device 10 includes a charging platform 11, a number of first electromagnetic induction devices 12, a first current processing module 13, a first microprocessor 14, and a position sensor 15. The first microprocessor 14 is electrically connected to the first electromagnetic induction devices 12, the first current processing module 13, and the position sensor 15. The first current processing module 13 is electrically connected to the first electromagnetic induction devices 12 and a power source (not shown).

The charging platform 11 is a rectangular plate, and includes an upper surface 111 and a side surface 112. The charging platform 11 defines a matrix of receiving holes 111a in the upper surface 111 and an electrical socket 112a in the side surface 112. The electrical socket 112a is electrically connected to the power source. In this embodiment, 5×5 matrix of receiving holes 111a are shown, but it should be understood that the number and arrangement of the receiving holes 111a are not limited thereto.

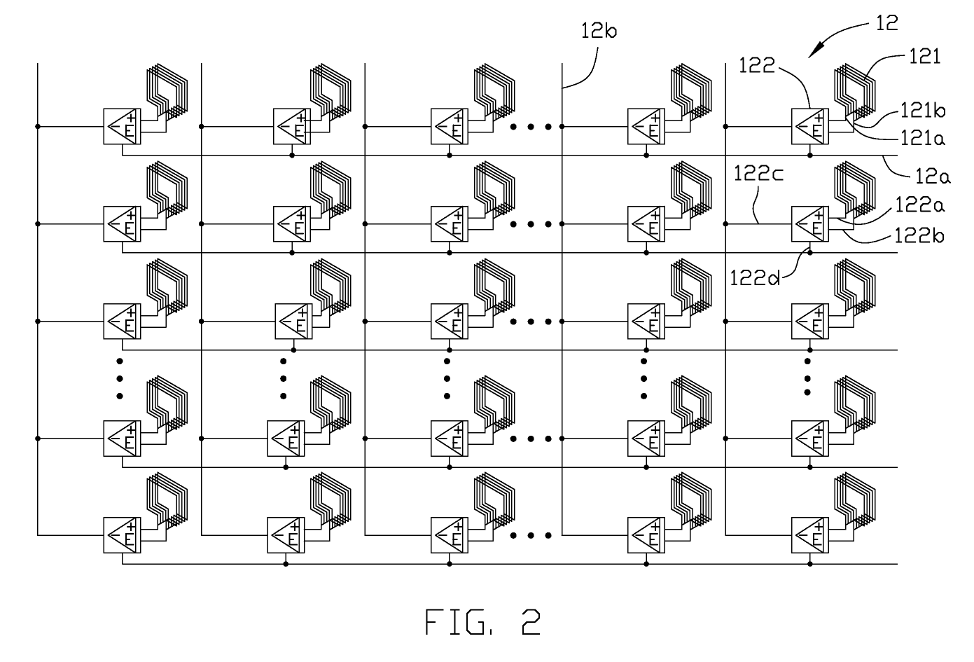

Also referring to FIG. 2, the first electromagnetic induction devices 12 are received in the receiving holes 111a correspondingly and include a number of gate lines 12a and a number of output lines 12b. Each gate line 12a is disposed in the charging platform 11 along a corresponding line of receiving holes 111a. Each output line 12b is disposed in the charging platform 11 along a corresponding row of receiving holes 111a. Each first electromagnetic induction device 12 includes an inductor 121 and a differential unit 122.

The inductor 121 is a coil and includes a first output terminal 121a and a second output terminal 121b. The inductor 121 is operable to generate an induced current in an electromagnetic field or generate an electromagnetic field when supplied with an alternating current.

The differential unit 122 is operable to generate a differential signal associated with the induced current of the inductors 121 and includes a first input terminal 122a, a second input terminal 122b, a third output terminal 122c, and a gate terminal 122d. The first and second input terminals 122a, 122b are connected to the first and second output terminals 121a, 121b, respectively, the differential unit 122 receives an induced current from the inductor 121. The gate terminals 122d in the same line are connected to a corresponding gate line 12a. The third output terminals 122c in the same row are connected to a corresponding output line 12b. The gate line 12a is operable to receive a gate signal from the first microprocessor 14 so as to activate the differential units 122 connected to the corresponding gate line 12a. The output line 12b is operable to output the differential signal, e.g., a differential voltage associated with the induced current of the inductor 121 connected to the activated differential unit 122.

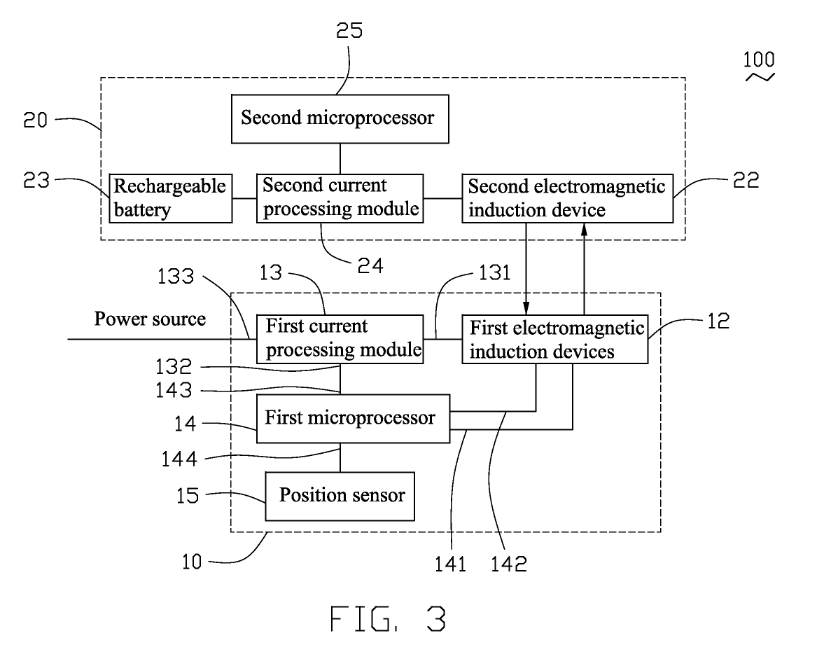

Also referring to FIG. 3, the first current processing module 13 is configured for modulating the current of the power source. The first current processing module 13 includes a current output terminal 131, a signal input terminal 132, and a power input terminal 133. The current output terminal 131 is electrically connected to the first output terminal 121a and the second output terminal 121b. The power input terminal 133 is electrically connected to the electrical socket 112a.

The first microprocessor 14 is configured for identifying the first electromagnetic induction devices 12 generated the induced current and controlling the first current processing module 13 to modulate the alternating current from the power source. The first microprocessor 14 includes a first controlling terminal 141, a second controlling terminal 142, a third controlling terminal 143, and a fourth controlling terminal 144. The first controlling terminal 141 and the second controlling terminal 142 are electrically connected to the gate lines 12a and the output lines 12b respectively. The third controlling terminal 143 is electrically connected to the signal input terminal 132.

The position sensor 15 is disposed on the upper surface 111 adjacent to the side surface 112 of the charging platform 11. The position sensor 15 is configured for detecting whether another electronic device 20 is placed on the charging platform 11.

The electronic device 20 includes a cover 21, a second electromagnetic induction device 22, a rechargeable battery 23, a second current processing module 24, and a second microprocessor 25. The cover 21 is configured for housing the second electromagnetic induction device 22, the rechargeable battery 23, the second current processing module 24, and the second microprocessor 25. The second current processing module 24 is electrically connected to the second electromagnetic induction device 22 and the rechargeable battery 23. The second microprocessor 25 is electrically connected to the second current processing module 24.

The second electromagnetic induction device 22 is disposed on the cover 21, and is operable to generate an induced current in an electromagnetic field or generate an electromagnetic field when supplied with an alternating current.

The rechargeable battery 23 is configured for storing electrical energy and providing electrical energy to other elements of the electronic device 20. Commonly, when the electronic device 20 is power off and the rechargeable battery 22 is depleted, little residual electrical energy still remains in the rechargeable battery 22.

The second current processing module 24 is configured for converting an alternating current generated by the second electromagnetic induction device 22 into a direct current to charge the rechargeable battery 23 in one mode, or converting residual electrical energy of the rechargeable battery 23 into an alternating current in another mode.

The second microprocessor 25 is configured for controlling an operation mode of the second current process module 24. That is, a mode of converting alternating current into direct current or the other mode of converting residual electrical energy of the rechargeable battery 23 into alternating current.

To charge the rechargeable battery 23 of the electronic device 20, the electronic device 20 is changed to a charging mode, and placed on the charging platform 11. In the charging mode, the second microprocessor 25 controls the second current processing module 24 to convert residual electrical energy of the rechargeable battery 23 into an alternating current. The alternating current is inputted to the second electromagnetic induction device 22 to produce an electromagnetic field. The inductors 121 of the first electromagnetic induction devices 12 on the charging platform 11 directly below the electronic device 20 generate an induced current due the electromagnetic field.

When the electronic device 20 is placed on the charging platform 11, the position sensor 15 generates a detection signal to the first microprocessor 14. The first controlling terminal 141 sends an enable signal to one of the gate lines 12a sequentially to activate the lines of differential units 122 sequentially. The second controlling terminal 142 reads the differential signals from the differential units 122 that are activated. The first microprocessor 14 is operable for detecting the first electromagnetic induction devices 12 outputting effective differential signals. In this embodiment, the effective differential signal is higher than a predetermined value outputted by the first electromagnetic induction devices 12.

After a predetermined time the electronic device has been placed on the loading plate, the second microprocessor 25 controls the second current process module 24 to stop converting the residual electrical energy of the rechargeable battery 23 into an alternating current. In the embodiment, the predetermined time is typically longer than the time the first microprocessor 14 takes to identify the first electromagnetic induction devices 12 that are outputting an effective differential signal. The first microprocessor 14 controls the first current processing module 13 to modulate the alternating current of the power source. Then, the alternating current is supplied to the first electromagnetic induction devices 12 generating the effective differential signals. The first electromagnetic induction devices 12 convert alternating current into electromagnetic fields. The second electromagnetic induction device 22 generates an induced current under the electromagnetic field. The second microprocessor 25 controls the second current processing module 24 to convert the induced current to a directed current that charges the rechargeable battery 23.

When an additional electronic device 20 is placed on the charging platform 11, the position sensor 15 generates a detection signal to the first microprocessor 14. The first microprocessor 14 activates the first electromagnetic induction devices 12 that do not in the charging state and identifies the first electromagnetic induction devices 12 generated the induced current. Then the first microprocessor 14 controls the first electromagnetic induction devices 12 to charge the additional electronic device 20.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A charging device, comprising:
a charging platform;
a plurality of first electromagnetic induction devices disposed on the charging platform;
a first microprocessor configured for activating the first electromagnetic induction devices and identifying the first electromagnetic induction devices that generated effective differential signals; and
a first current processing module configured for inputting an alternating current to the first electromagnetic induction devices identified by the first microprocessor.

2. The charging device in claim 1, wherein the charging platform comprises an upper surface and a side surface, and defines a plurality of receiving holes to receive the first electromagnetic induction devices and an electrical socket to connect to a power source.

3. The charging device in claim 1, wherein the plurality of first electromagnetic induction devices are arranged in lines and rows; each first electromagnetic induction device comprises an inductor and a differential unit, the inductor comprises a first output terminal and a second output terminal, and the differential unit comprises a first input terminal, a second input terminal, a third output terminal, and a gate terminal; the first input terminal is connected to the first output terminal, the second input terminal is connected to the second output terminal, the gate terminals in one line are connected to a gate line, the third output terminals in one row are connected to an output line.

4. The charging device in claim 3, wherein the first current processing module comprises a current output terminal, a signal input terminal, and a power input terminal; the current output terminal is connected to the first output terminal and the second output terminal, the power input terminal electrically is connected to the power source.

5. The charging device in claim 1, wherein the first microprocessor comprises a first controlling terminal, a second controlling terminal, and a third controlling terminal; the first controlling terminal and the second controlling terminal are connected to the gate line and the output line respectively, the third controlling terminal is connected to the signal input terminal.

6. The charging device in claim 1, wherein the charging device further comprises a position sensor, the position sensor is disposed on the upper surface adjacent to the side surface of the charging platform; the position sensor is configured for detecting whether there is an electronic device placed on the charging platform.

7. A charging system, comprising:
a charging device comprising:
a charging platform;
a plurality of first electromagnetic induction devices disposed on the charging platform;
a first microprocessor configured for activating the first electromagnetic induction devices and identifying the first electromagnetic induction devices that generated effective differential signals; and
a first current processing module configured for inputting an alternating current to the first electromagnetic induction devices identified by the first microprocessor;
an electronic device to be placed on the charging platform for charging, comprising:
a second electromagnetic induction device configured to generate induced current under electromagnetic fields, and
a rechargeable battery storing the electrical energy generated by the second electromagnetic induction device.

8. The charging system in claim 7, wherein the electronic device further comprises a second current processing module configured for converting residual electrical energy of the rechargeable battery into alternating current under one operation mode and converting alternating current generated by the first electromagnetic induction device into direct current under another operation mode.

9. The charging system in claim 8, wherein the electronic device further comprises a second microprocessor configured for controlling the second current processing module to change the operation mode.
